(19) United States
(12) Patent Application Publication
(10) Pub. No.: US 2005/0262115 A1
(43) Pub. Date: Nov. 24, 2005

(54) Extensible constraint markup language

(76) Inventors: Jingkun Hu, Pleasanton, CA (US); Lixin Tao, Blauvelt, NY (US)

Correspondence Address: PHILIPS INTELLECTUAL PROPERTY & STANDARDS, P.O. BOX 3001, BRIARCLIFF MANOR, NY, 10510, US

(21) Appl. No.: 11/110,591

(22) Filed: Apr. 20, 2005

Related U.S. Application Data
(60) Provisional application No. 60/568,167, filed on May 5, 2004.
(60) Provisional application No. 60/609,675, filed on Sep. 13, 2004.

(51) Int. Cl. G06F 7/00

(52) U.S. Cl. 707/100

(57) ABSTRACT

Methods and systems for specifying and validating dynamic semantic constraints on extensible Markup Language (XML) documents are disclosed. The new XML constraint language, extensible Constraint Markup Language (XCML), is more expressive than the current constraint languages by better supporting the specification of dynamic and inter-relationship constraints. Unified Modeling Language (UML) and Object Constraint Language (OCL) are adopted to support visual specification and automatic generation of XCML instance documents and XML Schemas, which are further used by reusable XSLT stylesheets to support both semantic and syntactical XML document validation.

### CROSS REFERENCE TO RELATED CASES

Applicants claim the benefit of Provisional Application Ser. Nos. 60/568,167, filed May 5, 2004, and 60/609,675, filed Sep. 13, 2004.

This invention relates to the field of software development and particularly to a methods and systems to specify and validate non-structural constraints of XML documents.

### BACKGROUND AND PRIOR ART

Behind the success of e-business on the Internet is the ever-increasing demand for business-to-business (B2B) enterprise system integration. The data processing systems of different companies need to communicate with each other to share data, pass business transactions, and hierarchically integrate finer-grain services into coarser ones. Data integration is becoming critical for communicating parties to have a common language and understand each other's data.

The extensible Markup Language (XML), standardized by the World Wide Web Consortium (W3C) in February 1998; further described in Bray, T., et al. “Extensible Markup Language (XML) 1.0,” World Wide Web Consortium (W3C) Recommendation, 1998, http://www.w3.org/TR/1998/REC-xml-19980210; is self-describing, human and machine readable, extensible, flexible, and platform neutral. XML has become the standard format for exchanging information across the networks. To achieve the goal of data integration, the communicating parties need to agree on an XML dialect for their particular business domain and needs. This dialect is usually defined in a Document Type Definition (DTD) or XML Schema document, which defines the syntax and data types to which all of its instance XML documents must conform. The data source will generate XML data according to their DTD or Schema definition. The data consumer system can use an XML validating parser to verify the incoming data's syntax before passing them to its data processing system.

While syntax validation is important in preventing erroneous data from disrupting the data consumer system, it cannot verify the equally important non-structural semantic constraints on XML data. In reality, the value or presence of an element may depend on the value or presence of another element; and the value scope of an element may vary for different document instances and be decided by system environment. A grammatically validated XML document does not guarantee itself to be meaningful. Even though XML Schema is much more powerful than DTD, it cannot be used to specify non-structural constraints. There is a need for an extensible, expressive, platform-neutral, and domain-independent way of specifying semantic constraints on XML documents.

Another challenge for data integration is the specification of complex constraints on business data models. While in theory a text editor can be used to specify such constraints in a particular constraint specification language, the complexities of real-world business data structures could make such constraint specifications cryptic and error-prone. Ideally such constraints could be specified at a more abstract data model level so the human users can visually help verify the constraints, and the constraint documents could be derived from such models mechanically.

The third challenge is about constraint validation. XML validating parsers cannot use the constraint documents to validate non-structural constraints. Hard coding such constraints into a program is not attractive, since such a program may not truthfully implement the constraints, is not flexible for system modifications or extensions, and cannot be reused. Mature XML technologies should be used to provide a generic framework for automatic constraint validation.

Classification and Specification of XML Constraints

While XML syntactic constraints specify the static structure of a type of XML document, an XML semantic constraint imposes static/dynamic limitations to value/presence (occurrence) of the elements/attributes of a type of XML document.

An XML instance document exists in its system environment and its element/attribute values are usually cross-referenced in multiple documents. If an XML semantic constraint is conditional to its environment, it is called dynamic; otherwise it is called static. A dynamic constraint may impose different limitations on an element or attribute for different instance documents defined by the same Schema.

A constraint can be expressed in the form of an assertion (true/false statement) or a conditional rule (if-then) with embedded assertions. While in theory the constraints could be all expressed as assertions, rule-based constraints allow for more natural and concise specification of many types of constraints.

For an assertion-based constraint, it is called simple or composite depending on whether it involves one element/attribute or more.

For a rule-based constraint, it is called simple if it is of an if-then structure; or composite if it contains an else-clause or nested rule-based constraints.

Both syntactic and semantic constraints on XML documents, that commonly appear in the literature, can be classified into one of the following categories:
1. Well-formedness constraints: those imposed by the definition of XML itself such as the rules for the use of the < and > characters and the rules for proper nesting of elements.
2. Document structure constraints: how an XML document is structured starting from the root of a document all the way to each individual sub element and/or attribute.
3. Data type/format constraints: those applied to the value of an attribute or a simple element.
4. Value constraints: the value (range) of an element/attribute that cannot be specified by a DTD or XML Schema document; such constraints could be either static or dynamic.
5. Presence constraints of attributes and/or elements: the presence of an attribute or element and the number of occurrences of an element, which could be either static or dynamic.
6. Inter-relationship constraints between elements and/or attributes: the presence or value of an element/attribute depends on the presence or value of another element/attribute.
7. Consistency constraints: corresponding elements/attributes in multiple documents have consistent values.

The above categories 1 and 2 are for syntactic constraints, and categories 3 through 7 are for semantic constraints. Constraints in categories 1 through 3 can be specified by DTD or Schema documents and validated with an XML validating parser. Constraints in categories 4 through 5 are usually more natural to be specified with assertions, and constraints in categories 6 and 7 are usually more natural to be specified with conditional rules.

While XML Schema is richer than DTD in expressing the structures, data types, and data formats, it is not powerful enough to express semantic constraints. There have been three options to extend XML Schema in expressing semantic constraints:
1. to supplement XML Schema with another XML constraint language,
2. to write program code to express semantic constraints, and
3. to express semantic constraints with an XSLT/XPath stylesheet.

The advantage of the second option is that with a single programming language you can express all the semantic constraints. But, it cannot leverage XSLT technology. Each of the constraint documents becomes a legacy application. In the third option, each application creates its own stylesheet to specify and check constraints that are unique to the application. However, these stylesheets are not human-oriented and not reusable. It is also a challenge to create complex stylesheets. Therefore, the first option is preferable.

The major XML constraint languages in the literature are Schematron, XML Constraint Specification Language (XCSL), XincaML, and xlinkit. Schematron, a pattern-based XML constraint language, can express a substantial number of semantic constraints, specifically assertion-based constraints. It is the most popular XML constraint language among the existing ones. But it is difficult to express rule-based constraints and dynamic constraints. XCSL has not been used widely and has the disadvantages similar to Schematron. XincaML, recently proposed by IBM, focuses on the inter-relationship constraints. It cannot express dynamic constraints and requires a proprietary application to perform validation because it does not leverage XSLT, a core XML technology. Xlinkit is intended for the consistency check of elements among distributed XML documents.

Accordingly, there exists a need for a new XML constraint language to respond to the shortcomings of the prior art.

### SUMMARY OF THE INVENTION

A first objective of the present invention is to provide a method and system for specifying semantic constraints on XML documents.

A second objective of the present invention is to provide a method and system to express both static and dynamic semantic constraints in either the simple or composite form.

A third objective of the present invention is to provide a framework for visually modeling XML constraints over XML data models.

A fourth objective of the present invention is to provide a method for automatic generation of XCML documents from constrained logical XML data models.

A fifth objective of the present invention is to provide a framework for automatic constraint validation of non-structural constraints.

An improved and more expressive XML-based eXtensible Constraint Markup Language (XCML) is disclosed to specify various semantic constraints including dynamic and inter-relationship constraints. Unified Modeling Language (UML) and Object Constraint Language (OCL) are used to support visual specification of XML constraints. XML Metadata Interchange (XMI) and XSLT are used for automatic generation of XCML instance documents and XML Schemas. Thus it greatly reduces the complexity in designing complex XML data structures with extensive semantic constraints. Reusable XSLT stylesheets are designed to transform the XCML and Schema instance documents for an XML data model into model-specific stylesheets that can implement both semantic and syntactical XML document validation with an XSLT/XPath processor.

Further objects and advantages of this invention will be apparent from the following detailed description of the presently preferred embodiments that are illustrated schematically in the accompanying drawings.

### BRIEF DESCRIPTION OF THE FIGURES

FIG. 1 shows the UML profile for XCML Schema.

FIG. 2 shows the workflow of deriving XML Schema and XCML instance documents.

FIG. 3 shows the constrained conceptual model of Employee profile.

FIG. 4 shows the constrained logical model of Employee profile.

FIG. 5 shows the workflow of XML document validation.

### DESCRIPTION OF THE PREFERRED EMBODIMENTS

Before explaining the disclosed embodiments of the present invention in detail it is to be understood that the invention is not limited in its application to the details of the particular arrangements shown since the invention is capable of other embodiments. Also, the terminology used herein is for the purpose of description and not of limitation.

The existing constraint languages cannot express certain constraints including dynamic value/occurrence constraints and composite rule-based constraints. The present invention, a new XML constraint language—XCML, is an XML based markup language. XCML provides a set of syntax elements to express both static and dynamic semantic constraints in their either simple or composite forms.

It leverages the core XML technologies including XML Schema and XPath. The XCML syntax is defined in an XML Schema document. XCML instance documents can be either embedded within XML Schemas as annotations or as separate constraint documents. Table 1 compares the expressiveness of Schematron, XincaML, XCSL, and XCML.

TABLE 1
Expressiveness Comparison of Constraint Languages

| | Assertion-based constraint | | | | Rule-based constraint | | | |
|---|---|---|---|---|---|---|---|---|
| | simple | | composite | | simple | | composite | |
| Language | static | dynamic | static | dynamic | static | dynamic | static | dynamic |
| Schematron | Yes | No | Yes | No | Yes | No | No | No |
| XincaML | Yes | No | Yes | No | Yes | No | Yes | No |
| XCSL | Yes | Yes | Yes | Yes | Yes | No | No | No |
| XCML | Yes | Yes | Yes | Yes | Yes | Yes | Yes | Yes |

The XCML instance documents are simple, concise, easy to create, and easy to use to validate XML documents. It supports not only assertion-based constraints and simple rule-based constraints, such as if-then, but also composite rule-based constraints such as nested if-then-else. XCML supports parameters for expressing dynamic constraints. It supports XPath 1.0 or later so that various expressions can be processed by XPath-supporting XSLT processors. XCML also supports the visual specification of constraints on XML data models.

XCML Syntax

The XCML syntax is defined in an XML Schema document. An XCML document contains a single top-level element Constraints, which contains a sequence of one or more Constraint elements. A Constraint element must specify its scope through its context attribute. It starts with an optional sequence of Parameter elements, each specifying the name, type, and optional default value of a parameter for passing in an external environment value. The main body of a Constraint element is either a Rule element or an Assertion element. A Rule element is basically a sequence of If element, Then element, and an optional Else element. An If element allows for the specification of an assertion as the value of its test attribute. A Then element or an Else element allows for the specification of either an assertion as the value of its test attribute, or a nested if-then-(else) structure.

XCML Instance Document Samples

Provided are simple examples to demonstrate that XCML can be used to specify constraints that some of the other constraint languages cannot, as summarized in Table 1.

1. Simple and Dynamic Assertion-Based Constraints

This example declares that in the context of element “employee,” the value of “taxRate” must be equal to the value of parameter “rate”, which is dynamically set by the system environment.

```
<Constraint context=“employee”>
    <Parameter>
        <name>rate</name>
        <type>decimal</type>
        <defaultValue>0.07</defaultValue>
    </Parameter>
    <Assertion test=“taxRate=$rate”/>
</Constraint>
```

2. Composite and Dynamic Assertion-Based Constraints

This example declares that in the context of element “employee,” the value of “tax” must be equal to the value of element “income” multiplied with the value of parameter “rate”, which is dynamically set by the system environment.

```
<Constraint context=“employee”>
    <Parameter>
        <name>rate</name>
        <type>decimal</type>
        <defaultValue>0.07</defaultValue>
    </Parameter>
    <Assertion test=“tax=income*$rate”/>
</Constraint>
```

3. Simple and Dynamic Rule-Based Constraints

This example declares that in the context of element “employee,” if the value of “income” is less than or equal to the value of parameter “level,” then the value of “taxRate” should be 0.05.

```
<Constraint context=“employee”>
    <Parameter>
        <name>level</name>
        <type>decimal</type>
    </Parameter>
    <If test=“income<=$level”/>
    <Then test=“taxRate=0.05”/>
</Constraint>
```

4. Composite and Static Rule-Based Constraints

This example declares that in the context of element “employee,” if the value of “income” is less than or equal to $50,000, then the value of “taxRate” should be 0.05; otherwise if the value of “income” is less than or equal to $100,000, then the value of “taxRate” should be 0.07; otherwise the value of taxRate should be 0.1.

```
<Constraint context=“employee”>
    <If test=“income<=50000”/>
    <Then test=“taxRate=0.05”/>
    <Else>
        <If test=“income<=100000”/>
        <Then test=“taxRate=0.07”/>
        <Else test=“taxRate=0.1”/>
    </Else>
</Constraint>
```

5. Composite and Dynamic Rule-Based Constraints

This example declares that in the context of element “employee,” if the value of “income” is less than or equal to the value of parameter “level1,” then the value of “taxRate” should be 0.05; otherwise if the value of “income” is less than or equal to the value of parameter “level2,” then the value of “taxRate” should be 0.07; otherwise the value of “taxRate” should be 0.1.

```
<Constraint context=“employee”>
    <Parameter>
        <name>level1</name>
        <type>decimal</type>
    </Parameter>
    <Parameter>
        <name>level2</name>
        <type>decimal</type>
    </Parameter>
    <If test=“income<=$level”/>
    <Then test=“taxRate=0.05”/>
    <Else>
        <If test=“income<=$level2”/>
        <Then test=“taxRate=0.07”/>
        <Else test=“taxRate=0.1”/>
    </Else>
</Constraint>
```

Table 1 summarizes the expressiveness of four XML constraint languages Schematron, XincaML, XCSL, and XCML based on our classification of semantic constraint forms.

Visual Modeling of XML Semantic Constraints

The generation of XML constraint documents for real-world complex XML documents is a challenging topic. Even though XCML syntax supports more natural specification of many semantic constraints, XCML documents are still system-oriented and not easy for communicating with domain experts.

The present invention provides a model-driven approach to automate the XCML document generation process. The approach is based on visual modeling of XML data structures (XML data modeling) and the three-level-design approach (conceptual, logical, and physical levels) for generating XML Schema documents.

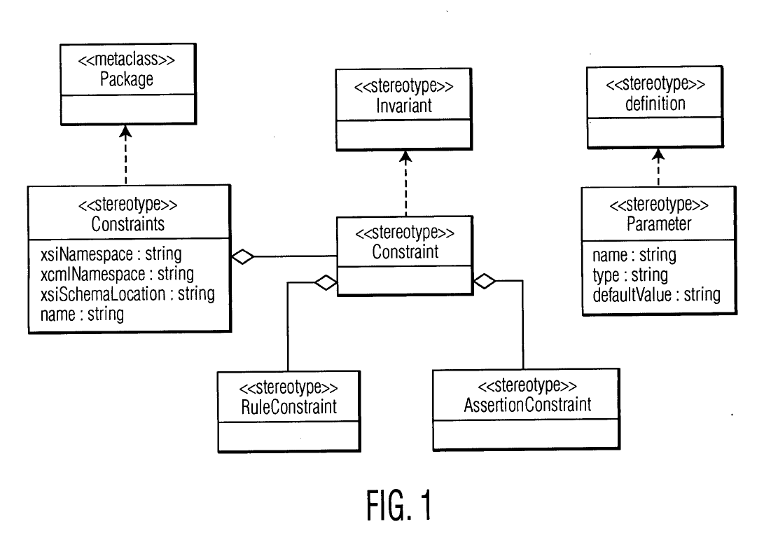

The approach of the present invention starts with a UML class diagram representing the visual modeling of an XML data structure. The invariant structure of OCL is used to specify semantic constraints associated with classes, attributes, or associations. The resulting model is the constrained conceptual one, which can facilitate communications between domain experts/users and data modelers. The constrained logical model is obtained from the constrained conceptual model after annotating its classes, attributes and associations with stereotypes from Carlson's UML profile for XML Schema; further described in Carlson, D. “Modeling XML Applications with UML: Practical e-Business Applications”, Addison-Wesley, 2001; and the UML profile for XCML Schema of the present invention as described in FIG. 1.

In order to derive logical models from conceptual models, the domain specific vocabularies need to be put onto the models. UML profile, a UML extension mechanism using stereotypes, is used to represent those vocabularies. Two UML profiles are needed to realize this task. One is a set of UML stereotypes to represent W3C XML Schema vocabularies. We choose Carlson's for representing XML Schema vocabularies. The other is a set of UML stereotypes to represent XCML schema vocabularies.

Package is the standard UML metaclass. Invariant is a stereotype of constraints in OCL 1.4. definition is a stereotype of constraints in OCL 2.0. Constraints, Constraint, RuleConstraint, AssertionConstraint, and Parameter are the stereotypes extending UML/OCL to XCML schema.

Constraints is a stereotype with a base type of Package. In an XCML document, the root element Constraints constrains all the definitions for the namespaces of W3C XML Schema and XCML schema. If a UML package is assigned this stereotype, all the OCL constraints will be placed within one XCML document. Stereotype Constraints has four tagged values: xsiNamespace, xcmlNamespace, xsiSchemaLocation, and name.
xsiNamespace is a URL representing the W3C XML Schema definition namespace. The default value is http://www.w3.org/2001/XMLSchema-instance.
xcmlNamespace is a URL representing the XCML schema definition namespace. The default value is http://www.csis.pace.edu/dps/xcml.
xsiSchemaLocation is the XCML schema location. The default value is http://www.csis.pace.edu/dps/xcml Constraints.xsd.
name is the Constraints name.

Constraint is a stereotype with a base type of Invariant. It defines a container element of an XCML constraint. It has no tagged value. It must contain either a Rule element or an Assertion element.

RuleConstraint is a stereotype with a base type of Invariant. It defines an element of a rule-based constraint. It has no tagged value. If an Invariant constraint is assigned with this stereotype, it must contain one If element, one Then element, and zero or one Else element. AssertionConstraint is a stereotype with a base type of Invariant. It defines an assertion-based constraint. It has no tagged value. If an Invariant constraint is assigned with this stereotype, it must contain one Assertion element.

Parameter is a stereotype with a base type of definition. It defines a parameter given by a name with a datatype and optional default value. The stereotype definition is only supported in OCL 2.0.

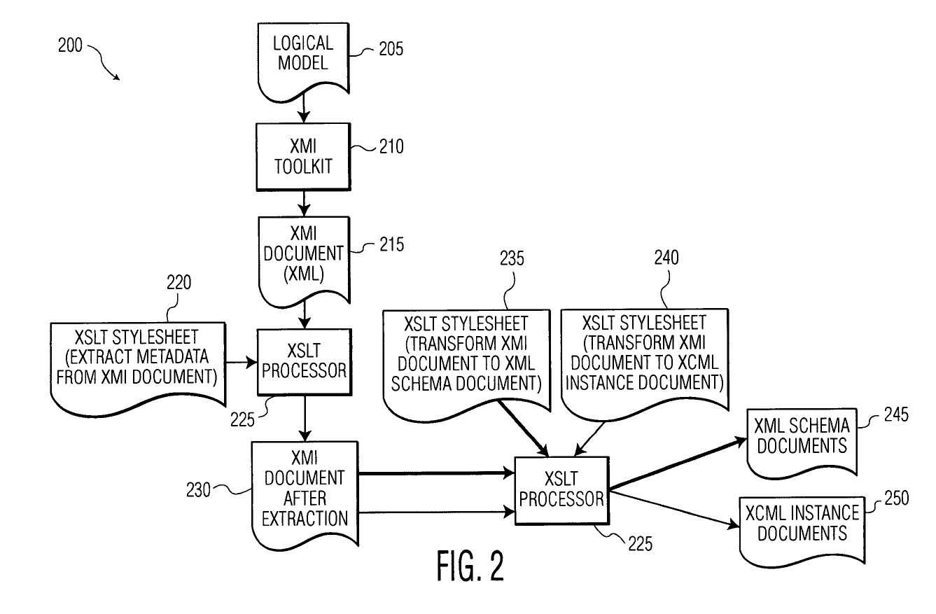

Referring now to FIG. 2, the physical models are XML Schema 245 and XCML instance 250 documents derived from the constrained logical models 205. XML Metadata Interchange (XMI) 210 and XSLT technologies are utilized to accomplish this task. The major advantage of doing so is that both XMI and XSLT are open standards and their toolkits are open source and freely available. We designed and implemented three reusable sets of XSLT stylesheets. A constrained logic model 205 is first written in an XMI (a kind of XML) file 215. The first XSLT stylesheet 220 was used to extract information related to classes, associations, and constraints out of the XMI file 215 with the help of an XSLT processor 225. The extracted partial XMI document 230 is further processed by the same XSLT processor 225, to derive XML Schema document 245 according to the second XSLT stylesheet 235, and to derive XCML document 250 according to the third XSLT stylesheet 240.

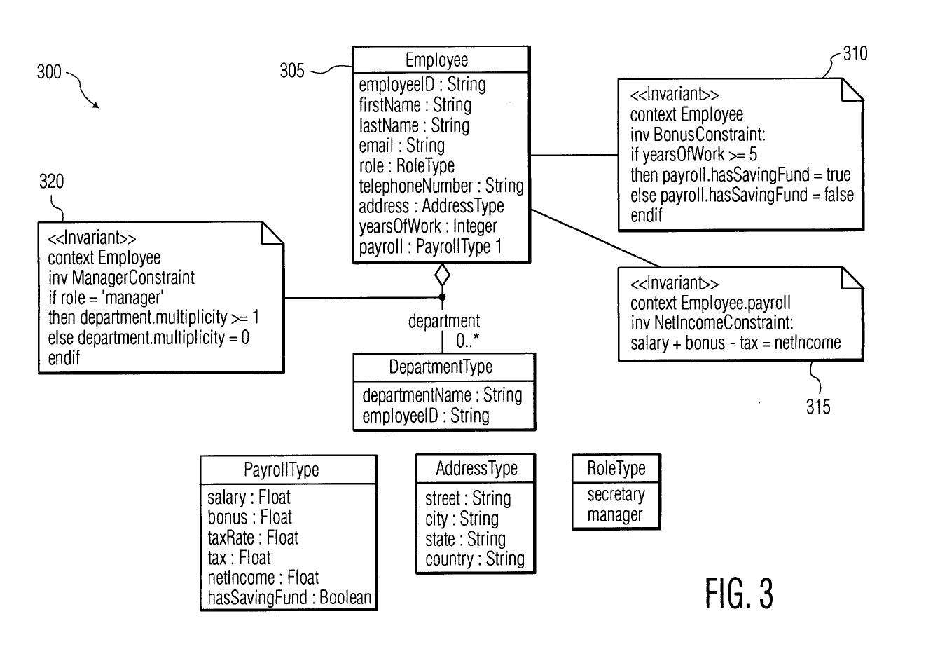

A concrete example for an Employee profile 300 is presented. FIG. 3 shows the constrained conceptual model in which three semantic constraints are specified with OCL invariants (1) an employee has savings fund if and only if he/she has worked for five years in the company 310; (2) an employee's net income should be equal to his/her salary plus his/her bonus minus his/her tax 315; (3) an employee will manage one or more departments if and only if he/she is a manager 320.

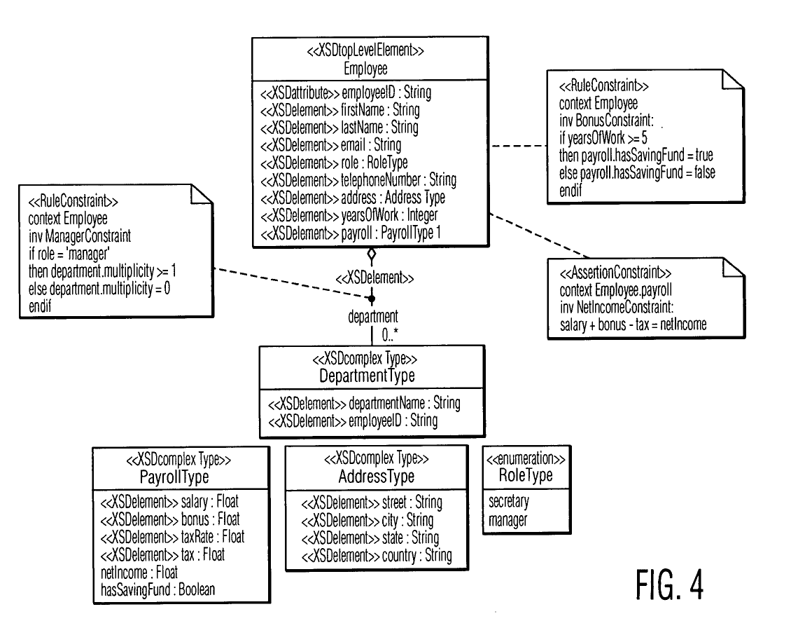

FIG. 4 shows the constraint logical model for the Employee profile.

This logical model is annotated with the XML Schema vocabularies and XCML schema concepts. Class Order is assigned stereotype XSDtopLevelElement, which means that Order will be mapped to the root element of an instance document for Order. OrderID is assigned stereotype XSDattribute, which means that orderID will be mapped to an attribute of the root element Order. In the same way, constraint ManagerConstraint and BonusConstraint are assigned to stereotype RuleConstraint, which means that these constraints will be mapped to a Rule element within a Constraint element under the root element Constraints. Constraint NetIncomeConstraint is assigned to stereotype Assertion Constraint, which means that this constraint will be mapped to an Assertion element.

Listing 1 below shows the XCML instance document derived from the constrained logical model for the Employee profile of FIG. 4.

```
<?xml version=“1.0” encoding=“UTF-8”?>
<xcml:Constraints xmlns:xcml=“http://www.csis.pace.edu/dps/xcml”>
    <Constraint context=“employee”>
        <Rule>
            <If test=“role=‘manager’”/>
            <Then test=“count(department) &ge; 1”/>
            <Else test=“count(department) = 0”/>
        </Rule>
    </Constraint>
    <Constraint context=“employee”>
        <Rule>
            <If test=“yearsOfWork = 5”/>
            <then test=“payroll/hasSavingFund = ‘true’”/>
            <Else test=“payroll/hasSavingFund = ‘false’”/>
        </Rule>
    </Constraint>
    <Constraint context=“employee/payroll”>
        <Assert test=“salary + bonus − tax = netIncome”/>
    </Constraint>
</xcml:Constraints>
```

### Listing 1: XCML Instance Document for Employee Profile

XSLT-Based XML Constraint Validation

While the syntactic validation of an XML document is straightforward once its XML Schema is available, the semantic validation of an XML document is much more complicated. The present invention performs the semantic validation of an XML document against its XCML instance document.

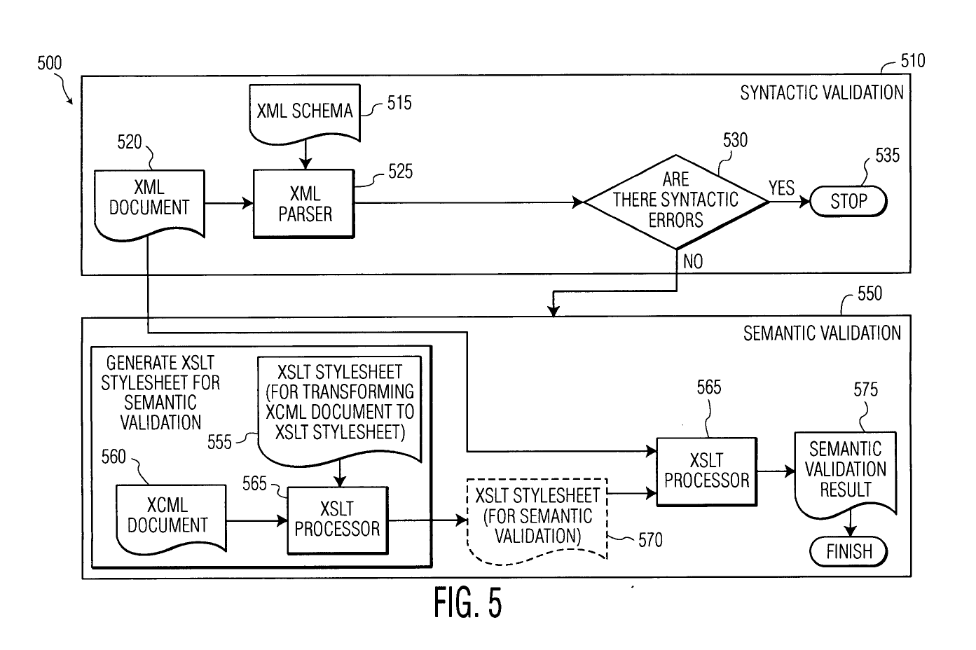

The workflow of validating XML documents is shown in FIG. 5. The syntactic validation against XML Schemas is executed in the first step 510. If there are any syntactic errors 530, the validation process stops 535. Otherwise, the semantic validation 550 is performed.

A reusable XSLT stylesheet 555 is written to convert an XCML instance document 560 into a model-specific XSLT stylesheet 570 with the help of an XSLT processor 565. The model-specific XSLT stylesheet 570 is, in turn, used to semantically validate the XML instance documents 520, with the help of an XSLT processor 565, to see whether their contents make sense to the particular application. The validation result can be shown in an XML document 575.

For the invention, the XSLT process is an available tool, while the reusable stylesheets are part of the invention.

The present invention provides a complete framework for XML semantic constraint specification, modeling, document generation, and validation, all based on public domain technologies XML, XML Schema, UML, OCL, XSLT, and XPath. Its potential applications include system data integration, XML data management, data warehousing, and decision support systems for various industry domains like e-commerce.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

1. A method of specifying the semantic constraints of an extensible Markup Language (XML) document, comprising the steps of:
(a) defining an XML Schema document;
(b) identifying one or more Constraint elements of said XML Schema document;
(c) specifying the Parameter elements of said Constraint elements;
(d) identifying a Rule element for said Constraint element; and
(e) identifying an Assertion element for said Constraint element.

2. A method of developing UML profile of XCML Schema, comprising the steps of:
(a) identifying the XML concepts of XCML Schema;
(b) identifying the corresponding UML stereotypes of said XML concepts;
(c) building an UML profile of XCML Schema; and
(d) the similar profile can also be built in the similar way.

3. A method of visually modeling semantic XML constraints over UML class models of XML data structures, comprising the steps of:
(a) defining a conceptual class model of said XML data structure;
(b) identifying one or more invariant constraints of said XML data structures;
(c) putting these constraints on the conceptual model, the said constraint conceptual class model is obtained; and
(d) annotating the XML Schema and XCML Schema concepts to said constraint conceptual model.

4. A method to automate the generation of XML constraint documents, comprising the steps of:
(a) using the constraint logical models as input;
(b) generating XMI output in XML format using XML toolkits;
(c) developing reusable XSLT stylesheets for transforming the XMI source to XCML Schema instance documents and also XML Schema documents for said constraint logical models; and
(d) generating XCML Schema instance documents and XML Schema documents using an available XSLT processor.

5. A method to validate an XML document, comprising the steps of:
(a) performing a syntactic validation of said XML document against an XML Schema; and
(b) performing a semantic validation of said XML document against an XMCL instance document comprising the steps of:
i. converting said XMCL instance document into an XSLT stylesheet; and
ii. semantically validating said XML document against said XSLT stylesheet.
